(19) United States
(12) Patent Application Publication
(10) Pub. No.: US 2024/0039057 A1
(43) Pub. Date: Feb. 1, 2024

(54) Electrochemical Cell, and Battery Assembly

(71) Applicant: Lina Energy Ltd., Lancaster (GB)

(72) Inventors: Richard James Dawson, Lancaster (GB); Jamie Parry Smith, Lancaster (GB); James Robert Houston Shaw Stewart, Lancaster (US)

(21) Appl. No.: 18/266,175

(22) PCT Filed: Dec. 8, 2021
(86) PCT No.: PCT/GB2021/053215

§ 371 Date: Jun. 8, 2023

(30) Foreign Application Priority Data
Dec. 9, 2020 (GB) 2019388.4

(51) Int. Cl. H01M 10/42; H01M 10/04; H01M 50/186; H01M 50/193; H01M 50/253; H01M 10/6563; H01M 10/39; H01M 10/0562; H01M 10/054; H01M 50/209; H01M 50/258

(52) U.S. Cl. CPC H01M 10/4235; H01M 10/0481; H01M 50/186; H01M 50/193; H01M 50/253; H01M 10/6563; H01M 10/39; H01M 10/0562; H01M 10/054; H01M 50/209; H01M 50/258; H01M 2300/0074

(57) ABSTRACT

An electrochemical cell (10) comprising an anode compartment (14) and a cathode compartment (15) each defined in part by a respective metal plate (11, 12), the anode compartment (14) of the cell when charged containing an alkali metal, and the of the alkali metal, and the anode compartment (14) also comprises a perforated planar sheet (24) of an inert metal immediately adjacent to the sheet (23) of ceramic, to provide support to the sheet of ceramic. The perforated metal sheet and the planar sheet of ceramic are formed separately. The cell (10) may be a sodium/metal halide cell; and multiple cells (10) which define edge flanges (20) may be stacked in an insulating frame (35), so a heat transfer fluid may be passed between the edge flanges (20) of the cells (10).

The present invention relates to an electrochemical cell, and to a battery assembly that comprises a multiplicity of such cells, and in particular to cell and a battery assembly that operates at an elevated temperature.

A number of different types of electrochemical cell are known that require an elevated temperature to operate. These include cells in which an electrolyte must be at elevated temperature to provide adequate conductivity; and cells in which an electrode must be at elevated temperature for an electrode component to be liquid. One such type of cell is a molten sodium-metal halide rechargeable battery, such as the sodium/nickel chloride cell which may be referred to as a ZEBRA cell (see for example J. L. Sudworth, “The Sodium/Nickel Chloride (ZEBRA) Battery Power Sources 100 (2001) 149-163). A sodium/nickel chloride cell incorporates a liquid sodium negative electrode separated from a positive electrode by a solid electrolyte which conducts sodium ions. The solid electrolyte may for example consist of beta alumina. The positive electrode includes nickel, nickel chloride and sodium tetrachloroaluminate which is liquid during use and acts as a secondary electrolyte to allow transport of sodium ions from the nickel chloride to the solid electrolyte. The positive electrode also incorporates aluminium powder. Partial replacement of the nickel with other transition metals such as iron can result in additional discharge voltage levels. The cell operates at a temperature which is typically below 350° C., but must be above the melting point of the sodium tetrachloroaluminate, which is 157° C., and the operating temperature is typically between 270° and 300° C. During discharge the normal reactions are as follows:

Cathode (positive electrode): NiCl₂₊₂ Na⁺+2e^{-→Ni+}2 NaCl

Anode (negative electrode): Na→Na⁺+e⁻

the overall result being that anhydrous nickel chloride (in the cathode) reacts with metallic sodium (in the anode) to produce sodium chloride and nickel metal; and the cell voltage is 2.58 V at 300° C.

A modified type of a ZEBRA cell, that is to say a molten sodium-nickel chloride rechargeable cell, is described in WO 2019/073260. This uses an electrolyte element that comprises a perforated sheet of non-reactive metal, and a non-permeable layer of sodium-ion-conducting ceramic bonded to one face of the perforated sheet. In this electrolyte element the strength can therefore be provided by the metal sheet, and this enables the electrolyte thickness to be significantly reduced as compared to that required in a conventional ZEBRA cell. This results in a cell or a battery that can perform adequately at significantly lower temperatures, for example less than 200° C. Furthermore a significantly thinner layer of ceramic also significantly reduces stresses induced by heating from ambient, so start-up times from ambient can be just a few minutes. These are both commercially advantageous benefits. The non-permeable layer is bonded to the perforated metal sheet, and this bonding may be by a porous ceramic sub-layer. Such a cell includes a metal case, which may have a peripheral flange. However there are some applications in which a different electrolyte structure may be preferred.

According to a first aspect of the present invention there is provided an electrochemical cell comprising an anode compartment and a cathode compartment each defined in part by a respective metal plate, the anode compartment of the cell when charged containing an alkali metal, and the cathode compartment of the cell when charged containing a cathodic material that can react reversibly with ions of the alkali metal; wherein the anode compartment is separated from the cathode compartment by a sheet of a ceramic that can conduct ions of the alkali metal, and wherein the anode compartment and/or the cathode compartment also comprises a perforated sheet of an inert metal adjacent to the sheet of ceramic over substantially its entire area, to provide support to the sheet of ceramic. The ceramic sheet is formed separately from the perforated sheet, rather than being formed by deposition onto it.

The sheet of ceramic and the perforated sheet of metal may both be planar. The sheet of ceramic may for example be rectangular, square, or any other polygonal shape; it may have rounded corners; or it may be circular or elliptical. It determines the area of the cell through which ionic conduction occurs between the two electrode compartments. The sheet of ceramic provides the electrolyte of the cell, so it may be referred to as a ceramic electrolyte.

The alkali metal may be lithium, sodium, potassium or rubidium; sodium is a suitable metal. The anode compartment may also comprise a carbon felt, preferably highly porous, to assist in the transfer of sodium metal away from or towards the sheet of ceramic, during charging and discharging of the cell. The carbon felt is highly porous, and preferably graphitic, and may for example have a density of less than 60 kg/m³, for example 20 or 15 or kg/m³.

The metal of which the perforated sheet is formed is “inert” in the sense that it does not react chemically with components of the cell with which it is in contact during use; it may for example be a metal such as nickel, or aluminium-bearing ferritic steel (such as the type known as Fecralloy (TM), or a steel that forms an electronically-conductive and adherent scale, for example a CrMn oxide scale, when heated in air. The perforated sheet may be of thickness no more than 1.0 mm, or no more than 0.5 mm, for example 0.1 mm or mm. The sheet is perforated so it has a very large number of through holes, and the perforations or holes may be of mean diameter less than 50 μm, for example 30 μm or less, or of mean diameter between 50 μm and 300 μm, and may for example be produced by a laser drilling process or by chemical etching. The through holes may have their centres spaced apart at between 100 μm and 500 μm, for example 150 μm, or may be closer to provide a higher proportion of open area.

The perforated planar sheet of inert metal may be immediately adjacent to the sheet of ceramic and in contact with the sheet of ceramic, over substantially its entire area, to provide support to the sheet of ceramic. Alternatively, there may be a layer of a permeable wicking material sandwiched between the perforated metal sheet and the sheet of ceramic; this wicking material will enhance the contact between molten alkali metal and the face of the sheet of ceramic that acts as the electrolyte. One suitable wicking material is a felt of carbon fibres; another option is a porous form of a ceramic such as Nasicon; and another option would be porous metal alloy that is readily wetted by molten alkali metal.

The perforated sheet may have a margin around its periphery that is not perforated; this margin may make it easier to seal the periphery of the perforated plate to adjacent components of the cell. This margin may be of width no more than 15 mm, for example 10 mm or 5 mm or 3 mm. This is in the case that the perforated sheet is substantially the same shape and area as the sheet of ceramic. In an alternative the perforated sheet does not extend to the edges of sheet of ceramic, and in this case the perforated sheet would be held up against the ceramic sheet electrolyte either by the felt within the anode compartment or by being adhered to the electrolyte by a sintering of a porous layer between the metal and the electrolyte. In another option the perforated sheet is held onto the electrolyte by providing portions of the periphery of the sheet that are curved or bent over so that they bear resiliently against the inner face of the metal plate that defines the anode compartment.

The perforated sheet is preferably in the anode compartment, where it will help wick the molten sodium towards the surface of the ceramic sheet. It is in contact with the ceramic sheet over the area of the ceramic sheet through which sodium ion conduction occurs during use; the outer edge of the perforated sheet may also be in contact with the ceramic sheet, or may be stepped away from the ceramic seat to provide for a peripheral seal between their edges. The edge of the perforated sheet may be welded to the adjacent anode plate.

In an alternative, the perforated sheet may be held up against the planar sheet of ceramic, i.e. the electrolyte, over its entire area by being adhered to the electrolyte by a sintering of a porous layer between the metal and the electrolyte. The sintering of the porous layer may be carried out at a lower temperature than that used to form the ceramic electrolyte layer, for example at 1100° C., 1000° C. or less, by including a sintering aid in the composition used to form the porous layer. The metal of the perforated sheet preferably has a coefficient of thermal expansion slightly greater than that of the planar sheet of ceramic, so that at the operating temperature of the cell the sheet of ceramic is held under compression.

The metal plates that define in part the anode compartment and the cathode compartment are also of inert metal, in the sense that they do not react with the contents of the respective compartments during use. They may be of stainless steel, or the metals mentioned above as suitable for the perforated sheet. They may be of a dished shape, with a flat rim. The flat rim of the plate forming the cathode compartment seals to the periphery of the sheet of ceramic, and the opposite face of the periphery of the sheet of ceramic is in contact with the periphery of the perforated sheet, which in turn may be sealed to the flat rim of the sheet forming the anode compartment.

Such a cell operates at an elevated temperature. For example, a conventional sodium/nickel chloride cell, or ZEBRA cell operates at 280° C. or 300° C. The operating temperature depends in part on the nature of the electrolyte and its ionic conductivity; a cell with a thin layer of ceramic as the electrolyte may have a lower operating temperature, for example in the range 175° C. to 225° C. In any event the sealing between the cell components must remain tight at the elevated temperature of operation. The sealing may utilise a high-temperature polymer such as a polyimide (e.g. KaptonTM) or PTFE, or an inorganic material of an electrical insulator, such as mica or vermiculite. Such high-temperature polymers are preferably not used to seal the anode compartment, as they may interact with the molten sodium. The sealing of the edge of the metal plate defining the anode compartment to either the electrolyte sheet or to the non-perforated rim of the perforated metal plate may use a graphite gasket for example.

The peripheries of the elements that are sealed together as described above must be held securely together. The rim of the sheet forming one compartment may project beyond the peripheries of the other elements, and that projecting part may be crimped over the peripheries of the other elements to hold them securely together.

A cell formed in this way will therefore define a projecting flange which is thinner than the region of the cell that contains the anode and cathode compartments. Where multiple such cells are stacked together to provide a higher electrical output, the temperature of the cells may be controlled by a heat transfer fluid, such as air, arranged to flow in the gaps between such flanges.

Hence in a second aspect the invention provides an electric battery assembly that comprises a multiplicity of cells that operate at an elevated temperature as described above, each cell having a metal case with a projecting flange, the cells being arranged in at least one stack, and the assembly comprising at least one generally rectangular frame that defines a rectangular aperture to locate a stack of cells, such that the flanges of the cells in the stack are adjacent a wall of the frame. Heat transfer to or from the cells may be achieved by causing air or another heat transfer fluid to flow along the paths defined by the gaps between the flanges of adjacent cells and bounded by the wall of the frame.

Each cell as described above has a metal case whose opposite faces have opposite polarity, so that cells can be stacked directly in contact with each other, all with the same orientation, with all the cells of the stack being electrically in series.

The rectangular frame may be of a metal such as steel, or may be a thermally insulating frame of a thermal insulation material, so it inhibits heat loss from the cells to the environment, and its strength and durability must be unaffected when in thermal contact with the cells at their operating temperature, which may be up to 200° C., 300° C. or 400° C., depending on the type of cell. A suitable material may have a density less than 300 kg/m³ and a thermal conductivity less than 0.05 W/m.K. One such material is a resin-bonded sheet of rock wool fibres (made by melting rock and forming fibres from it), for example that available under the name Rockwool (trade mark), which may have a density of 100 or 140 kg/m³ and a thermal conductivity between 0.03 and 0.04 W/m.K. Another suitable material is a microporous fumed silica material like that sold by Vacutherm under the brand VACUPOR, and this provides even better thermal insulation, with a thermal conductivity that may be as little as 0.01 W/m.K.

The electric battery assembly may also include a pump to pass a heat transfer fluid through each frame, so that the heat transfer fluid flows between the flanges of the cells adjacent to the wall of the frame. This heat transfer fluid may be air. In this case the pump may be a fan. There may also be a heater to heat the heat transfer fluid, for raising the temperature of the cells. The heater may be an electric heater. It will be appreciated that the heat transfer fluid desirably does not undergo a phase change over the temperature range between ambient temperature and the operating temperature of the cells, so air is suitable for this purpose where the operating temperature is for example less than 400° C. During operation the cells will generate heat, so during operation the heat transfer fluid will be used to transfer heat away from the cells, to maintain the cells at an optimum operating temperature.

In a further aspect, the electric battery assembly may be modular, each module comprising a stack of the cells located within one such rectangular frame, with the flanges of the cells in the stack adjacent to a wall of the frame. The wall of the frame may define a recess or wide groove open at one end but closed at the other end on two walls of the frame, the recess or wide groove locating edges of the cells of a stack, and the closed end of the recess preventing the stack from passing right through the frame.

Two or more such modules with insulating frames may be aligned with each other, the insulating frames being shaped to fit together, and may be combined with a module that incorporates a pump for a heat transfer fluid, such as a fan for air as mentioned above.

Each insulating frame may also define apertures through the walls of the frame to enable electrical contact to be made with the stack of cells. To simplify making electrical contact, each stack of cells may be provided with endplates, each endplate defining at least one electrical contact. By way of example each endplate may define an internally threaded boss, to which a bolt can be connected, to connect to an electrical conductor such as a bus bar outside the insulating frame.

Where the cells define flanges on two opposed edges, the heat transfer fluid may be arranged to flow in a first direction between the flanges on one edge and the wall of the frame, through each frame of the assembly, and then be arranged to flow back in the opposite direction between the flanges on the opposite edge and the opposite wall of the frame, which may be an insulating frame. This requires baffles between successive modules to separate the two flows, and an end module for the assembly which causes the heat transfer fluid to reverse its flow direction; and at the other end the pump is arranged to cause flow only between the flanges on the one edge of the stack and the adjacent wall of the frame. Indeed there may optionally be two pumps, one pumping the heat transfer fluid into the assembly, to flow between the flanges on the one edge of the stack, and the other pumping the heat transfer fluid out of the assembly from between the flanges on the other edge of the stack.

The battery assembly described above provides the benefits of reduced weight and reduced volume, and with a simplified balance of plant. The thermally insulating frames not only inhibit heat loss from the cells, but also provide mechanical protection.

The invention will now be further and more particularly described, by way of example only, and with reference to the accompanying drawings in which:

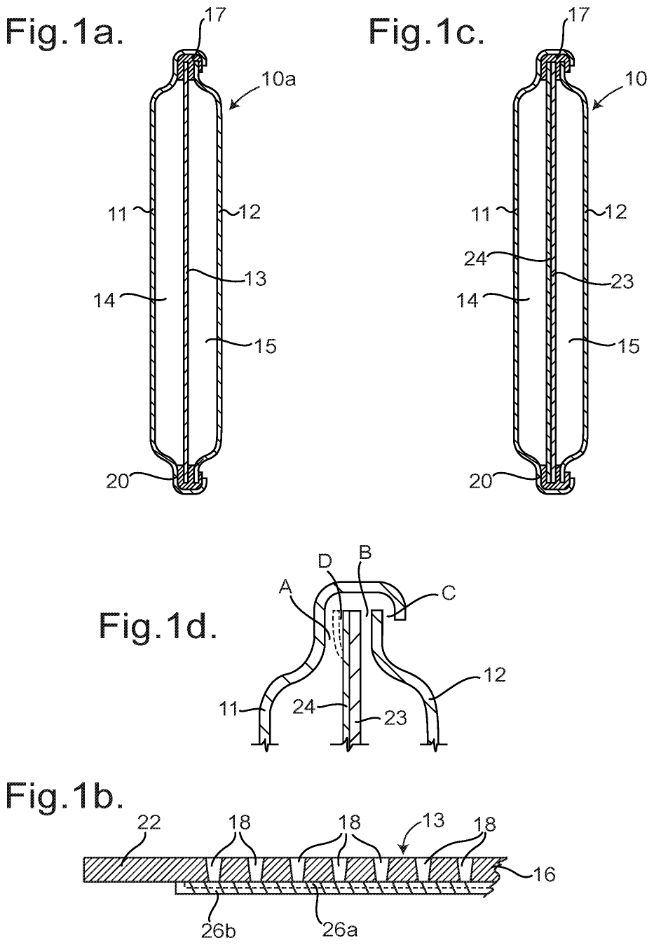

FIG. 1a shows a cross-sectional view through an electrical cell that is not a cell of the invention;

FIG. 1b shows a cross-sectional view of part of an electrolyte of a cell of FIG. 1a;

FIG. 1c shows a cross-sectional view through an electrical cell of the invention;

FIG. 1d shows part of the cell of FIG. 1c to a larger scale;

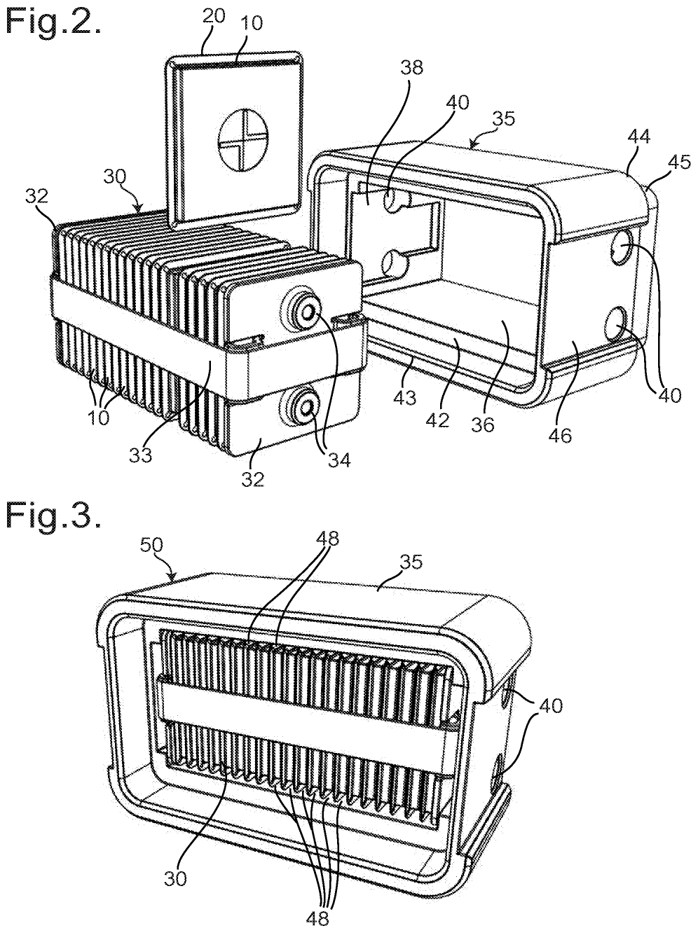

FIG. 2 shows a perspective view of a stack of cells, along with an insulating frame;

FIG. 3 shows a perspective view of the stack of cells inserted into the insulating frame of FIG. 2, which may be referred to as a battery module;

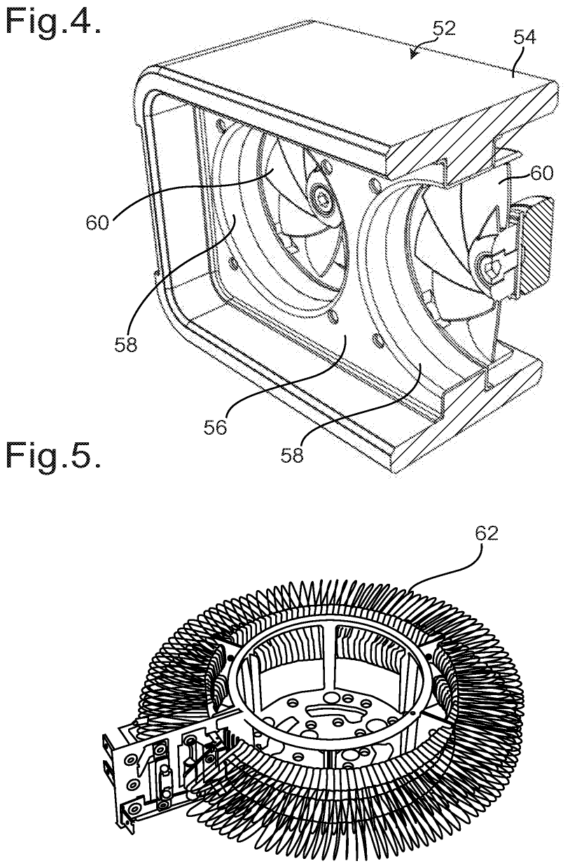

FIG. 4 shows a perspective view, partly in section, of an air fan module;

FIG. 5 shows a perspective view of an air heater;

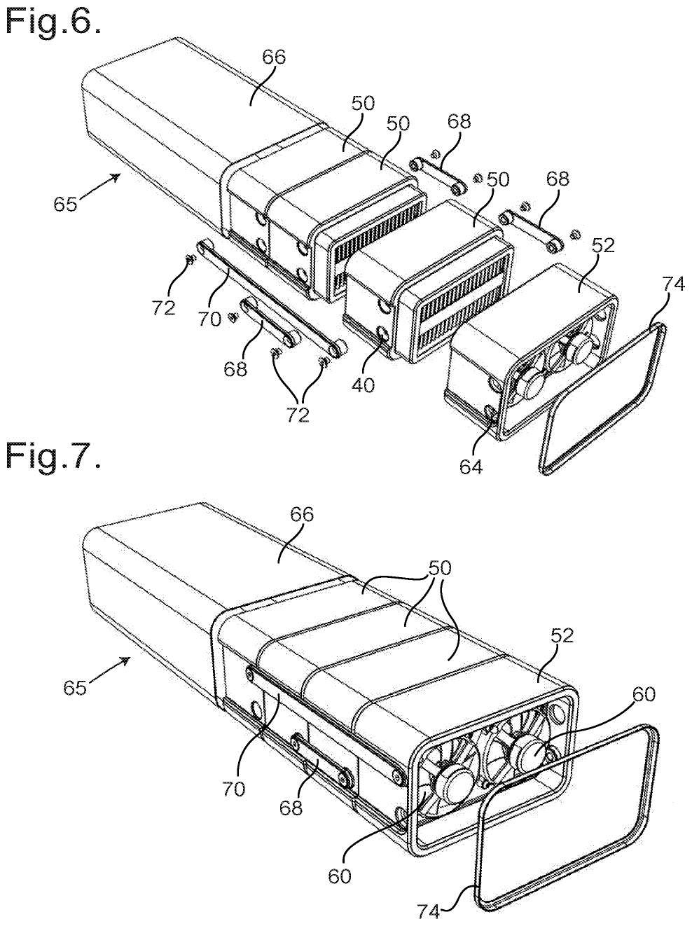

FIG. 6 shows a perspective exploded view of modules arranged for assembly into a casing;

FIG. 7 shows a perspective view at a subsequent stage of assembly;

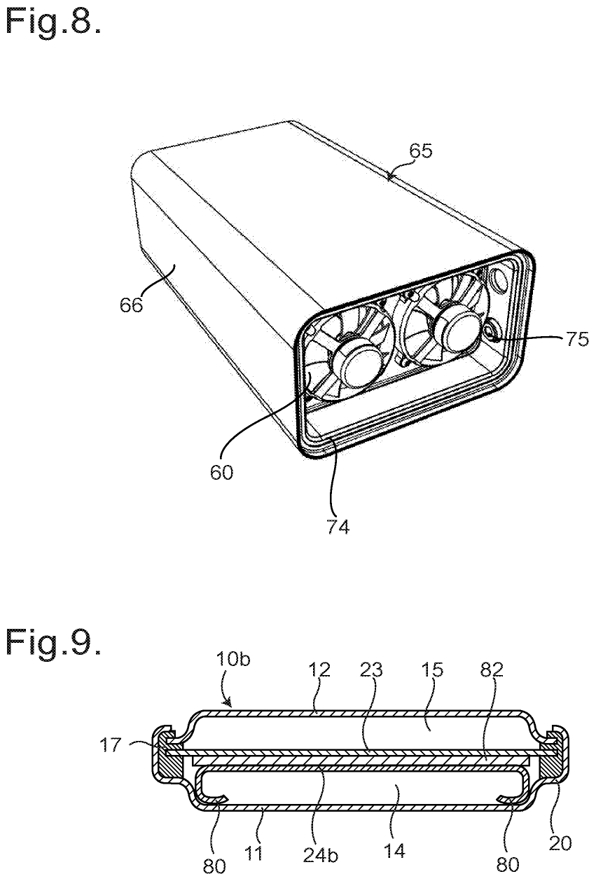

FIG. 8 shows a perspective view of the assembled electric battery assembly of the invention; and

FIG. 9 shows a modification to the cell of the invention as shown in FIG. 1c.

Referring to FIG. 1a, this shows a cell 10a which is described in UK patent application 2012728.8 and International application PCT/GB2021/052113 and is not the subject of the present invention. The cell 10a operates at an elevated temperature and comprises metal electrode plates 11 and 12, between which is a sheet of electrolyte 13. The electrode plates 11 and 12, together with the electrolyte sheet 13, define an anode space 14 on one side of the electrolyte sheet 13 and a cathode space 15 on the other side of the electrolyte sheet 13, which contain chemicals that interact as a consequence of the passage of ions through the electrolyte sheet 13 to generate electricity. Around their periphery the electrode plates 11 and 12 are sealed to the sheet of electrolyte 13 by a heat-resistant electrically-insulating sealant 17, and the edges of the electrode plates 11 and 12 and of the electrolyte sheet 13 form a projecting edge flange 20 around the periphery of the cell 10, the flange 20 being thinner than the remainder of the cell 10. In this example the cell components are held together by crimping the edge of the electrode plate 11 around the edges of the electrolyte sheet 13 and the electrode plate 12, all of which are separated by the insulating sealant 17, but in some cases the sealant 17 alone may hold the components together, so no such crimping is needed. In another modification there is no insulating sealant 17 between the edge of the electrolyte sheet 13 and the edge of one of the electrode plates 11 or 12, for example the plate 11 that forms the anode space 14; these edges may be hermetically welded together, and in this case the insulating sealant 17 only separates the edge of the plate 12 from both the plate 11 and the electrolyte sheet 13. The required operating temperature clearly depends upon the nature of the chemicals and the nature of the material of the electrolyte sheet 13. For example, operation may require a temperature in the range 100° C. to 300° C.

In particular the cell 10a may be a sodium/metal halide cell. One such type of cell is a sodium/nickel chloride cell. The electrode plates 11 and 12 may be of stainless steel, and of dished form to define the anode space 14 and the cathode space 15; with a flat peripheral rim. The electrolyte sheet 13 may comprise a metal sheet 16 of a metal such as nickel, or aluminium-bearing ferritic steel (such as the type known as Fecralloy (TM)), or a steel that forms an electronically-conductive and adherent scale, for example a CrMn oxide scale, when heated in air. Most of the sheet 16 is perforated to produce a very large number of through holes 18, as shown schematically in FIG. 1b, the holes being of mean diameter 30 μm, potentially produced by a laser drilling process, or of mean diameter between 50 μm and 100 μm, and may for example be made by chemical etching. A margin 22 around the periphery of the metal sheet 16, typically of width 5 mm, is not perforated. The perforated portion of the sheet 16 is covered by a porous and permeable ceramic sub-layer 26a which is itself covered by a non-permeable ceramic layer 26b, the ceramic layer 26b being of a sodium-ion-conducting ceramic. The non-permeable ceramic layer 26b may for example comprise beta alumina, but in addition it may contain a material that forms a glass during the sintering process. Thus, although it is referred to as a ceramic layer, the term “ceramic” in this context includes combinations of ceramic and glass, as long as the layer is conductive to sodium ions during operation. The non-permeable ceramic layer must not be permeable, that is to say it would be impermeable to gases, and consequently impermeable to liquids during operation. The non-permeable layer 26b also covers the edges of the sub-layer 26a. In this cell 10a, the ceramic sub-layer 26a is formed on the surface of the metal sheet 16, so it is integral with the metal sheet 16.

The porous sub-layer 26a may be of the same sodium-ion-conducting ceramic as the non-permeable ceramic layer 26b, but would typically be formed from a slurry containing somewhat larger particles. The porous and permeable ceramic sub-layer 26a may be of thickness between 10 μm and 100 μm, while the non-permeable layer 26b may be of thickness in the range 5 μm to 50 μm, for example 20 μm, 30 μm or 40 μm.

In its charged state the cell 10a would contain sodium metal in the anode space 14 and nickel chloride in the cathode space 15. However, the cell would typically be assembled in a completely discharged state, with nickel powder mixed with sodium chloride in the cathode space 15. In practice the cathode space 15 would be initially filled with a powder mixture containing nickel powder, sodium chloride, and sodium aluminium chloride (sodium tetrachloroaluminate, NaAlCl₄) and preferably also a small proportion of other ingredients such as iron sulphide and iron chloride, and aluminium powder, and there may also be an expanded mesh nickel sheet embedded within the powder mixture to ensure good electrical contact. The anode space 14 may initially contain carbon felt, and the surfaces of the anode space 14 may be coated with carbon black.

For the cell 10a to operate, it must first be heated to a temperature above 157° C., such as 200° C., at which the sodium aluminium chloride is molten, and at such a temperature the non-permeable ceramic layer 26b will conduct sodium ions sufficiently. The molten sodium aluminium chloride enables sodium ions to diffuse between the sodium chloride and the non-permeable ceramic layer 26b. The cell can therefore be charged by applying a voltage from an external power supply between the two electrode plates 11 and 12, so sodium ions pass through the electrolyte sheet 13 into contact with the carbon felt in the anode space 14, where sodium metal is formed, while within the cathode space 15 the remaining chloride ions react with the nickel to form nickel chloride. The cell 10a is readily reversible, so it can be charged and discharged multiple times.

Referring now to FIG. 1c, this shows a cell 10 of the present invention. The cell 10 has many features in common with the cell 10a described above, identical components being referred to by the same reference numerals. The cell 10 may be a sodium/nickel chloride cell and may operate at about 200° C. It comprises metal electrode plates 11 and 12, between which is a sheet of electrolyte 23 immediately adjacent to a perforated metal sheet 24. The electrolyte sheet 23 is formed separately from the perforated metal sheet 24; for example, it may be made by electrophoretic deposition onto a polished metal substrate, and then dried, so that it separates from the metal substrate, and then sintered.

The electrode plates 11 and 12 are dished, so together with the electrolyte sheet 23, they define an anode space 14 on one side of the electrolyte sheet 23 and a cathode space on the other side of the electrolyte sheet 23, which contain chemicals that interact as a consequence of the passage of ions through the electrolyte sheet 23 to generate electricity. In its charged state the cell 10 would contain sodium metal in the anode space 14 and nickel chloride in the cathode space 15; the perforated metal sheet 24 is in the anode space 14, where it acts as a wick to enhance the movement of molten sodium within the anode space 14, and maximizes the contact area between the molten sodium and the electrolyte sheet 23. However, as described above in relation to the cell 10a, the cell 10 would typically be assembled in a completely discharged state, with nickel powder mixed with sodium chloride in the cathode space 15; there may also be carbon felt in the anode space 14. The cathode space 15 may initially be filled with powdered nickel and salt (NaCl), with some iron powder, iron sulphide and aluminium; the NaAlCl₄ would then be infiltrated under vacuum around these materials at a temperature above its melting point. Around their periphery the electrode plates 11 and 12 are sealed to the sheet of electrolyte 23 by a heat-resistant electrically-insulating sealant 17 such as mica or vermiculite, and the edges of the electrode plates 11 and 12 form a projecting edge flange 20 around the periphery of the cell 10, the flange 20 being thinner than the remainder of the cell 10. The components are held together by crimping the edge of the electrode plate 11 around the edges of the perforated sheet 24 and of the electrolyte sheet 23 and the electrode plate 12, with the insulating sealant 17 separating all the components, except that the perforated sheet 24 and the electrolyte sheet 23 are not separated.

The electrolyte sheet 23 is a sheet of sodium-ion-conducting ceramic such as NASICON or beta alumina, which may be referred to as beta alumina solid electrolyte (“BASE”). This sheet is not porous; but at temperatures above about 200° C. its ionic conductivity is high enough to allow sodium ions to pass through it at an adequate rate. This BASE sheet 23 is of thickness no more than 2.0 mm, for example 1.0 mm, 0.6 mm or 0.5 mm. The perforated sheet 24 is of an inert metal such as Fecralloy (TM), and of thickness between 20 μm and 500 μm, for example 50 μm, 75 μm, 150 μm or 200 μm; and it is perforated, for example by laser drilling or by chemical etching, to provide multiple through-holes of diameter 10 to 200 μm, for example 40 μm, over the entire area apart from the peripheral part that comes into contact with the sealant 17, this peripheral part having no perforations.

In FIG. 1c the sealant 17 is shown as a single item. There may instead be separate strips of sealant. Referring now to FIG. 1d, this shows the part of the cell 10 that forms the flange 20 to a larger scale, but the sealant 17 is not shown. Sealant 17 may be provided in a number of different regions: region A between the rim of the plate 11 and the periphery of the perforated sheet 24; region B between the periphery of the BASE sheet 23 and the rim of the plate 12; and region C between the crimped edge of the plate 11 and the outer face of the plate 12. In a modification in which the periphery of the perforated sheet 24 is stepped away from the periphery of the BASE sheet 23, as indicated in broken lines, there is also a region D between the periphery of the perforated sheet 24 and that of the BASE sheet 23. In one example a first strip of sealant extends through region A, around the edges of the sheets 23 and 24, and extends through region B, while a separate strip of sealant is provided in region C. In another example there is no sealant in region A, so the plate 11 is in contact with the periphery of the perforated sheet 24, while a strip of sealant extends through region B, around the edge of the plate 12 and extends through region C. In another example there are three separate strips of sealant, one in each of the regions A, B and C. And in the modification with the stepped edge to the sheet 24 there may be four separate strips, one in each of the regions A, B, C and D.

It will be appreciated that some sealant materials are more suitable for use in certain regions. A sealant exposed to the anode space 14, in which molten sodium may be present, for example between the electrolyte 23 and the perforated metal sheet 24 or between the perforated metal sheet 24 and the anode plate 11, may be a gasket of graphite, while a sealant exposed to the cathode space 15 may be of expanded PTFE.

In this example, the cell components are held together by crimping the edge of the electrode plate 11 around the edges of the perforated sheet 24 and of the electrolyte sheet 23 and the electrode plate 12, but it will be appreciated that the edges of the plates may alternatively be held together in other ways, for example with multiple clips.

In a modification, the edge of the perforated sheet 24 may be welded to the anode plate 11, so a strip of sealant extends through region B, around the edge of the plate 12 and extends through region C., or separate sealants may be provided in the regions B and C. If the edge of the perforated sheet 24 is welded to the anode plate 11, no carbon felt is required in the anode space 14.

Where a sealant is provided in region A, this sealant may be an inorganic material such as mica or vermiculite that does not react with sodium metal. Such materials may be used in all the regions A to D. Sealants that are provided in regions B, C or D do not come into contact with sodium metal, so a wider range of materials are suitable including high-temperature polymers such as PTFE, or polyimide.

Referring now to FIG. 2, twenty cells 10 (one is shown above the others) are assembled into a stack 30, all the cells 10 having the same orientation so that the cells 10 are electrically in series. At each end is an endplate 32 which defines two threaded bosses 34. The stack 30, including the endplates 32, is held together by a heat-resistant fabric strip 33. FIG. 2 also shows an insulating frame 35 of a porous ceramic material (such as a material produced by Rockwool or Vacutherm) having a texture somewhat similar to cardboard, but being an electrical and thermal insulator, with a thermal conductivity of 0.035 W/m.K or less. The frame 35 is generally rectangular, with rounded external corners, and defines a rectangular duct 36 to accommodate the stack 35. Each sidewall of the rectangular duct 36 defines a wide recess 38, and two circular apertures 40, one above the other, which communicate with that recess 38; the wide recess 38 extends to one end of the frame 35, but does not extend to the other end of the frame 35, terminating just beyond the location of the apertures 40.

The wall thickness of the frame 35 is greatest in the central portion into which the stack 30 can be placed; one end of the frame 35 defines a step 42 around the inside of the walls, so defining a projecting outer wall part 43, while the other end of the frame 35 defines a step 44 around the outside of the walls, so defining a projecting inner wall part 45. The dimensions are such that if two such frames 35 are aligned and pushed together, the projecting inner wall part 45 of one frame 35 fits closely within the projecting outer wall part 43 of the other frame 35. The frame 35 also defines a shallow recess 46 on the outside of each of the side walls, each such shallow recess extending the entire length of the frame and communicating with the circular apertures 40.

Referring also to FIG. 3, this shows the stack 30 located within the frame 35. The stack 30 cannot be inserted any further into the frame 35, because the threaded bosses 34 have reached the end of the recess 38. In this position the apertures 40 are aligned with the threaded bosses 34 on the endplates 32. The combination of the stack 30 within the frame may be referred to as a battery module 50. It will be appreciated that along the top and bottom surfaces of the stack 30 there are gaps 48 between the edge flanges 20 of adjacent cells 10, so in the battery module 50 there are multiple flow paths defined by the gaps 48 and the top and bottom walls of the frame 35.

By way of example each cell 10 may be 9 mm thick and 90 mm by 90 mm in plan, so the stack 30 of twenty cells 10 and endplates 32 is of length about 0.2 m. The insulating frame 35 may have a wall thickness of 20 mm or 30 mm.

Referring now to FIG. 4, an air fan module 52 comprises a thermally insulating rectangular frame 54, the walls of which may be of the same material as that used for the frame 35, and the external dimensions are also the same. One end of the frame 54 is of such a thickness that it can closely fit over the projecting inner wall part 45 of a battery module Mounted within the centre of the rectangular frame 54 is a stainless steel frame 56 which defines two short parallel stainless steel tubular ducts 58, and at one end of each duct 58 is mounted an electrically-driven fan 60. A low-pressure rapid airflow heater element 62, as shown in FIG. 5, may be mounted within each tubular duct 58. The insulating rectangular frame 54 also defines circular apertures 64 (shown in FIG. 6) to provide access to electrical output terminals 75 (one is shown in FIG. 8) mounted within the rectangular frame 54.

Referring now to FIG. 6, an electric battery assembly 65 is shown in exploded form. The assembly 65 in this example comprises a casing 66, three battery modules 50, and the air fan module 52. In addition, there are three short bus bars 68 and one long bus bar 70; eight screws 72; and a rectangular end ring 74. In this example the battery modules 50 are arranged electrically in series, so the stacks 30 in adjacent battery modules 50 are arranged in opposite orientations.

To assemble the electric battery assembly 65, the modules 50 are aligned and fitted together, with the projecting outer wall part 43 of one frame 35 fitting closely around the projecting inner wall part 45 of the adjacent frame 35, and the end wall part of the fan module 52 similarly fitting around the projecting inner wall part 45 of the adjacent frame 35. The insulating frames 35 and 54 thus form a continuous rectangular tubular duct that contains the stacks 30 and the fans 60. The bus bar 70 is then used to connect an output terminal 75 within the fan module 52 to one end of the stack 30 of the furthest battery module 50; and the bus bars 68 are used to connect the ends of successive stacks 30 together, and to connect one end of the stack 30 in the closest battery module 52 the other output terminal 75 within the fan module 52. Each connection of a bus bar 68 or 70 to a stack 30 uses a screw 72 to connect through a circular aperture 40 to the threaded boss 34 at the endplate 32 of the stack 30. It will be appreciated that the bus bars 68 and 70 locate within the shallow recesses 48. The assembly 65 is then as shown in FIG. 7.

The assembled modules 50 and 52 are then slid into the casing 66, and the end ring 74 is attached to the end of the casing 66, so securing the modules 50 and 52. The resulting electric battery assembly 65 is then as shown in FIG. 8.

In this example there is an air outlet (not shown) at the far end of the casing 66. In this situation the cells 10 of the stacks 20 can be initially heated up to operating temperature by activating both the low-pressure electrical air heaters 62 and the fans 60 so that hot air flows through the multiple flow paths defined by the gaps 48 between the edge flanges 20 of adjacent cells 10, and the top and bottom walls of the frame 35. Once the required operating temperature has achieved, which may for example be 180° C. or 210° C., the electrical heaters 62 may be switched off; and the fans 60 operated only to ensure the cells 10 do not overheat as a result of heat generated during use.

The initial heating may alternatively be achieved using hot air generated outside the assembly 65, obtained for example by combustion of a liquid fuel such as paraffin or diesel, or of a combustible gas, for example with an eberspacher external air heater (not shown), this hot air being supplied to the inlet of the fan module 52, so the fans 60 blow the hot air through the battery modules 50. Alternatively, such an external heater may be a high-power electrical heater, if sufficient electrical power is available. Once the required operating temperature has been reached, this external heater would be switched off and disconnected from the inlet to the fan module 52. Subsequently the operating temperature can be maintained by passage of ambient air blown by the fans 60, if cooling is required, or passage of air heated by the electrical heaters 62 and blown by the fans 60 if heating is required.

Whether this initial heating uses the electric heaters 62 or uses an external air heater, it may be beneficial to recycle the heated air that has passed through the assembly back through the heater, and then pass it through the assembly 65 again.

During use, the output terminals 75 are connected to an external electrical circuit, and the battery assembly 65 may be used to provide electric current to that external circuit. Similarly, if the cells 10 need to be recharged, this can be done by providing current via the output terminals 75 from an external charging circuit.

Throughout use, both during start-up, and during both discharging and charging of the cells 10, the fan module 52 enables the cells 10 to be kept at an optimum temperature, by heat transfer to and from the edge flanges 20. It will be appreciated that each battery module 50 may include temperature sensors (not shown) to enable the temperature of the cells 10 to be monitored.

In a modification, the fan module 52 has fans 60 arranged one above the other rather than side-by-side, arranged to create air flows in opposite directions, and includes a baffle (not shown) in each battery module 50 and the fan module 52 so that the air flow along the flow paths defined by the gaps 48 at the top of the cell stacks 30 is in the opposite direction to that along the flow paths defined by the gaps 48 at the bottom of the cell stacks In this case the other end of the casing 66 would be sealed and so arranged to allow flow between the flow paths along the top of the cell stacks 30 and the flow paths along the bottom of the cell stacks 30.

As described above, the cell stacks 30 are arranged electrically in series, so that the output voltage between the output terminals 75 is the sum of all the voltages of all the cells In some situations a lower voltage may be required, and the same battery modules 50 may be rearranged so that the cell stacks 30 are electrically in parallel.

In a further modification each battery assembly consists only of battery modules 50, and does not include a fan module 52. One or more such battery assemblies may be coupled to an external source of heat transfer fluid, for example an external air pump or fan, along with a heater. Hence this external source of heat transfer fluid may be used to keep each battery assembly at its optimum operating temperature.

As a further option, the battery stacks may include electrical heaters sandwiched between adjacent cells 10, and these electrical heaters are used to heat the cells 10 to the operating temperature. Once operating temperature has been achieved, flow of a heat transfer fluid such as air along the flow paths 48 between the edge flanges 20 may be used to take excess heat way from the cells 10 during use.

The cells of the invention include a ceramic sheet electrolyte that is formed separately from the perforated metal sheet. These components may remain separate in the assembled cell, or alternatively these components may be bonded together over their entire area before the cell is assembled. This bonding may be achieved by coating the facing surfaces of the ceramic sheet and the perforated metal sheet with a slurry of a precursor to the ceramic material, along with a sintering aid; placing these coated surfaces together, drying them, and then sintering so as to form a porous layer between the metal and the electrolyte sheets. The sintering of the porous layer may be carried out at a lower temperature than that used to form the ceramic electrolyte layer, for example at 1100° C., by virtue of the sintering aid. The sintering aid melts to form a glass at a lower temperature than would be required to sinter the ceramic; it may be a sodium borosilicate glass, or a sodium/transition metal/phosphate glass, or a glassy form of NASICON, i.e. sodium zirconium silicate phosphate glass. The metal of the perforated sheet preferably has a coefficient of thermal expansion slightly greater than that of the ceramic electrolyte sheet, so that at the operating temperature of the cell the ceramic sheet is held under compression; a ferritic steel such as Fecralloy (TM) is therefore suitable.

Another modification to the cell 10 of the invention is shown in FIG. 9; this shows a cell 10b which includes two modifications, but in other respects is the same as the cell 10 described above. Identical components are referred to by the same reference numerals. The cell 10b may be a sodium/nickel chloride cell and may operate at about 200° C. It comprises metal electrode plates that are an anode plate 11 and a cathode plate 12, between which is a sheet of electrolyte 23 adjacent to a perforated metal sheet 24b; the electrolyte sheet 23 is formed separately from the perforated metal sheet 24b.

The cell 10b differs firstly in that along two opposite sides, peripheral portions of the perforated metal sheet 24b are curved in to form springs 80 which contact the inner face of the anode plate 11 in the assembled cell 10b, so those springs 80 push the perforated metal sheet 24b resiliently towards the electrolyte sheet 23; and secondly in that a layer of carbon felt 82 is sandwiched between the perforated metal sheet 24b and the electrolyte sheet 23. Since the springs 80 ensure electrical contact between the perforated metal sheet 24b and the anode plate 11, no carbon felt is required in the anode space 14.

The carbon felt 82 is readily wetted by molten sodium, so it helps to wick molten sodium towards or away from the face of the electrolyte sheet 23. An alternative material for use as such a wicking material is porous Nasicon; and another alternative would be a porous sheet or coating of a tin/bismuth/nickel alloy, as long as the alloy has a melting point above the operating temperature of the cell 10b. The wicking layer may be bonded to the surface of the electrolyte sheet 23. The wicking layer helps utilise the full charge of the cell and ensures that the full rate charge can be provided by or supplied to the cell 10b.

As mentioned above, the cell 10b differs in two ways from the cell 10 described above: the resilient springs 80 and the wicking layer 82. It will be appreciated that the cell may instead be modified to incorporate either one of these different features.

1. An electrochemical cell comprising an anode compartment and a cathode compartment each defined in part by a respective metal plate, the anode compartment of the cell when charged containing an alkali metal, and the cathode compartment of the cell when charged containing a cathodic material that can react reversibly with ions of the alkali metal; wherein the anode compartment is separated from the cathode compartment by a sheet of a ceramic that can conduct ions of the alkali metal, and wherein the anode compartment and/or the cathode compartment also comprises a perforated sheet of an inert metal adjacent to the sheet of ceramic over substantially its entire area, to provide support to the sheet of ceramic, the ceramic sheet being formed separately from the perforated sheet, and there being a layer of a permeable wicking material sandwiched between the perforated metal sheet and the sheet of ceramic, the wicking material enhancing contact between molten alkali metal and the face of the sheet of ceramic that acts as the electrolyte.

2. (canceled)

3. The cell as claimed in claim 1 wherein the cell comprises resilient elements to push the perforated metal sheet towards the sheet of ceramic.

4. The cell as claimed in claim 1 wherein the perforated sheet is of thickness between 50 μm and 500 μm.

5. The cell as claimed in claim 1 wherein the perforations or holes are of mean diameter less than 300 μm.

6. The cell as claimed in claim 1 wherein the perforated sheet has a margin around its periphery that is not perforated.

7. The cell as claimed in claim 1 wherein the metal plates that define in part the anode compartment and the cathode compartment are of a dished shape, with a flat rim.

8. The cell as claimed in claim 7 wherein the flat rim of the plate forming the cathode compartment seals to the periphery of the sheet of ceramic, and the opposite face of the periphery of the sheet of ceramic is in contact with the periphery of the perforated sheet, which is sealed to the flat rim of the metal plate forming the anode compartment, and the sealing and insulating between the peripheries of cell components is obtained using a high-temperature polymer, such as a polyimide or PTFE, or an inorganic insulating material, such as graphite, mica or vermiculite.

9. The cell as claimed in claim 7 wherein the rim of the metal plate forming one compartment projects beyond the periphery of the metal plate forming the other compartment, and that projecting part is crimped over the peripheries of the perforated sheet, the sheet of ceramic, and the metal plate forming the other compartment, thereby holding them securely together.

10. An electric battery assembly that comprises a multiplicity of cells as claimed in claim 1, wherein each cell defines a metal case with a projecting flange, the cells being arranged in at least one stack, and the assembly comprising at least one generally rectangular frame that defines a rectangular aperture to locate a stack of cells, such that the flanges of the cells in the stack are adjacent a wall of the frame, and also comprising a pump to pass a heat transfer fluid through the aperture of each frame, so that the heat transfer fluid flows between the flanges of the cells adjacent to the wall of the frame.

11. (canceled)

12. The electric battery assembly as claimed in claim 11 wherein the heat transfer fluid is air.

13. The electric battery assembly as claimed in claim 10 wherein the electric battery assembly is modular, each module comprising a stack of the cells located within one such rectangular frame, the frame being of thermally insulating material, with the flanges of the cells in the stack adjacent to a wall of the insulating frame, such that two or more such modules may be aligned with each other, the insulating frames being shaped to fit together.

14. The electric battery assembly as claimed in claim 13 wherein each stack of cells is provided with endplates, each endplate defining at least one electrical contact, and each insulating frame defines apertures through the walls of the frame to enable electrical contact to be made with the stack of cells.

15. The electric battery assembly as claimed in claim 13 wherein the cells define flanges on two opposed edges, and the heat transfer fluid is arranged to flow in a first direction between the flanges on one edge and the wall of the insulating frame, through each insulating frame of the assembly, and then is arranged to flow back in the opposite direction between the flanges on the opposite edge and the opposite wall of the insulating frame.

16. A cell as claimed in claim 3 wherein the resilient elements are peripheral portions of the perforated metal sheet that are curved in to form springs which contact the inner face of the anode plate in the assembled cell, so those springs push the perforated metal sheet resiliently towards the electrolyte sheet.

17. A cell as claimed in claim 1 wherein the wicking material is a felt of carbon fibres, or a porous form of a ceramic such as Nasicon, or a porous metal alloy that is readily wetted by molten alkali metal.
